(19) United States
(12) Patent Application Publication
(10) Pub. No.: US 2025/0104620 A1
(43) Pub. Date: Mar. 27, 2025

(54) DISPLAY DRIVING CIRCUIT, HOST, DISPLAY SYSTEM INCLUDING THE SAME AND METHOD OF OPERATING THE DISPLAY DRIVING CIRCUIT

(71) Applicant: SAMSUNG ELECTRONICS CO., LTD., Suwon-si (KR)

(72) Inventors: Changju Lee, Suwon-si (KR); Woojoo Kim, Suwon-si (KR); Haksong Kim, Suwon-si (KR); Kyounghwan Kwon, Suwon-si (KR)

(21) Appl. No.: 18/887,681

(22) Filed: Sep. 17, 2024

(30) Foreign Application Priority Data
Sep. 25, 2023 (KR) 10-2023-0128529
Mar. 12, 2024 (KR) 10-2024-0034716

(51) Int. Cl. G09G 3/3208

(52) U.S. Cl. CPC G09G 3/3208; G09G 2310/08; G09G 2330/023; G09G 2370/08

(57) ABSTRACT

A display driving circuit operating in video mode is described. The display driving circuit includes an interface configured to receive, from an external source, sync signals and image data corresponding to each of a plurality of frames, a data processor configured to receive the image data from the interface and convert the image data, and a timing controller configured to generate internal control signals for driving a driver circuit based on the sync signals and the image data. The internal control signals are configured to be output only when the sync signals and signals corresponding to the image data are input simultaneously, and panel driving signals are configured to be output when the internal control signals are output.

### CROSS-REFERENCE TO RELATED APPLICATION

This application is based on and claims priority under 35 U.S.C. § 119 to Korean Patent Application Nos. 10-2023-0128529, filed on Sep. 25, 2023, and 10-2024-0034716, filed on Mar. 12, 2024, in the Korean Intellectual Property Office, the disclosures of which are incorporated by reference herein in their entireties.

### BACKGROUND

A display device includes a display panel that displays an image and a display driving circuit that drives the display panel. The display driving circuit may drive the display panel by receiving image data from a host and applying an image signal corresponding to the received image data to a data line of the display panel. The display device may be implemented in various forms, such as a liquid crystal display (LCD), a light-emitting diode (LED) display, an organic LED (OLED) display, and an active matrix OLED (AMOLED) display.

### SUMMARY

This disclosure provides a display system that can alleviate serious image defects in a display panel even when underrun occurs.

The disclosure relates to a display driving circuit, a host, a display system including the same, and a method of operating the display driving circuit, and more particularly, to operations of a display driving circuit and a host to alleviate screen defects due to underrun in a display system driven in video mode.

A display panel may be produced through a low-temperature polycrystalline oxide (LTPO) process. The pixel circuitry of the LTPO display panel may be maintained for a long time without loss of image data due to charge leakage. Accordingly, the display panel may be driven at a low frame rate. When the display panel is driven at a low frame rate, power consumption for the interface between the host and the display driving circuit may be reduced and the display device may operate in video mode. In video mode, image data received from the host may be displayed on the display panel without being stored in memory.

In a video mode, an external sync signal may be applied to the display driving circuit to drive the display panel at a variable refresh rate (VRR) and the display driving circuit may generate a panel driving signal based on the external sync signal. However, when the external sync signal is being input to the display driving circuit and corresponding data is not input to the display driving circuit, underrun may occur. When the underrun occurs, serious display distortion may occur.

A display driving circuit operating in a video mode is provided, including an interface configured to receive, from an external source, sync signals and image data corresponding to each of a plurality of frames, a data processor configured to receive the image data from the interface and convert the image data to generate a converted image data, and a timing controller configured to generate internal control signals for driving a driver circuit based on the sync signals and the image data, wherein the internal control signals are configured to be output based on the sync signals and signals corresponding to the image data being input simultaneously into the driver circuit, and wherein panel driving signals are configured to be output to a display panel based on the internal control signals being output to the driver circuit.

In some examples, there is provided a host including an interface configured to transmit image data corresponding to each of a plurality of frames through a first channel and to transmit sync signals through a second channel to a display driving circuit, a display processor configured to generate the image data, and a sync generator configured to generate the sync signals, wherein the sync generator is further configured to generate first sync signals and second sync signals, wherein the second sync signals are different from the first sync signals, and, when part of the image data generated from the display processor is not transmitted normally, the host is configured to operate in at least one of a first mode that delays output of the first sync signals corresponding to a next frame section of a section where part of the image data is not normally received by the display device or a second mode that outputs the first sync signals corresponding to the next frame section of the section where part of the image data is not normally received by the display device.

In some examples, there is provided a display system operating in video mode, including a host configured to transmit image data corresponding to each of a plurality of frames through a first channel and to transmit sync signals for synchronizing signals of a host and a display driving circuit through a second channel, and a display driving circuit configured to generate control signals for driving a display panel based on the sync signals and the converted image data, wherein the display driving circuit is further configured to generate the control signals only when the sync signals and the image data are normally input, and output panel driving signals when the control signals are generated.

In some examples, there is provided a method of operating a display driving circuit, the method including receiving image data and sync signals from a host, confirming whether the image data is normal data, and determining whether to output internal control signals applied to a driver for driving a display panel based on whether the image data is normal data.

### BRIEF DESCRIPTION OF THE DRAWINGS

Implementations of the present disclosure will be more clearly understood from the following detailed description taken in conjunction with the accompanying drawings in which:

FIG. 1 is a block diagram of a display system according to some implementations;

FIG. 2 is a block diagram of a partial configuration of a display device according to some implementations;

FIG. 3 is a block diagram explaining a display panel according to some implementations;

FIG. 4 is a circuit diagram of a pixel according to some implementations of FIG. 3;

FIG. 5A shows an example of output image data when underrun occurs;

FIG. 5B is a diagram explaining signal driving when underrun occurs;

FIGS. 5C and 5D are diagrams explaining data output when underrun occurs;

FIGS. 6A and 6B are timing diagrams for driving sync signals and pixels according to some implementations;

FIG. 6C is a timing diagram of an operation in a display driving circuit according to some implementations;

FIG. 7 is a timing diagram of an operation of a display system according to a first embodiment;

FIG. 8 is a timing diagram of an operation of a display system according to the first embodiment;

FIG. 9A is a diagram showing the output of sync signals in a host according to the first embodiment;

FIG. 9B is a diagram showing the output of sync signals in the host according to the first embodiment;

FIG. 10 is a diagram explaining the delay of sync signals in the host according to the first embodiment;

FIG. 11 is a timing diagram of an operation of a display system according to a second embodiment;

FIG. 12 is a timing diagram of an operation of a display system according to the second embodiment;

FIG. 13A is a block diagram of a display system according to some implementations;

FIG. 13B is a block diagram of a display system according to some implementations;

FIG. 14 is a timing diagram applying control of block control signals in the first embodiment;

FIG. 15 is a timing diagram applying control of block control signals in the second embodiment; and

FIG. 16 is a flowchart of a method of operating a display driving circuit, according to some implementations.

### DETAILED DESCRIPTION

Hereinafter, implementations are described in detail with reference to the accompanying drawings.

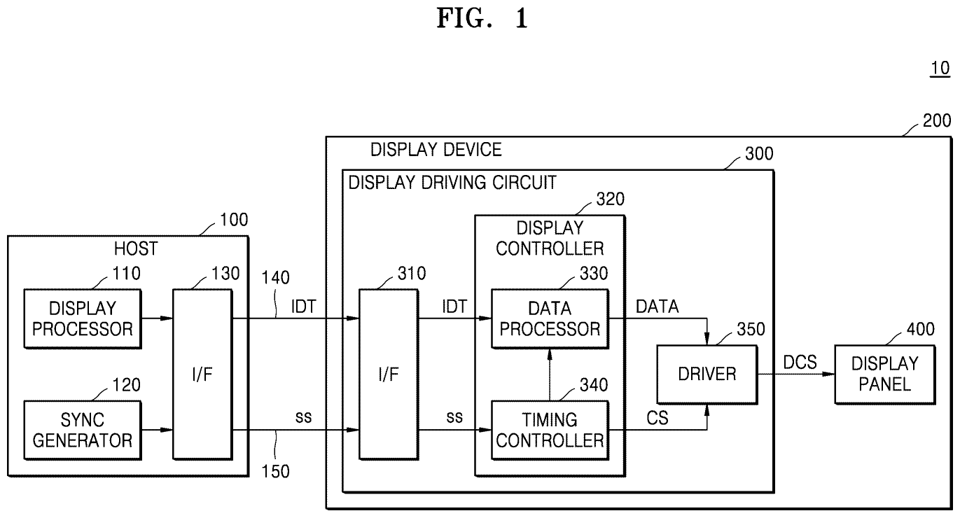

FIG. 1 is a block diagram of a display system according to some implementations.

A display system 10 according to some implementations may be mounted on an electronic device having an image display function. For example, the electronic device may include a smartphone, a tablet personal computer (PC), a portable multimedia player (PMP), a camera, a wearable device, the Internet of Things, a television, a digital video disk (DVD) player, a refrigerator, an air conditioner, an air purifier, a set-top box, a robot, a drone, various medical devices, a navigation device, a global positioning system (GPS) receiver, an advanced driver assistance system (ADAS), an automotive device, furniture or various measuring devices.

Referring to FIG. 1, the display system 10 may include a host 100, a display driving circuit 300, and a display panel 400. In some implementations, the display driving circuit 300 and the display panel 400 may be implemented as one module, and the module may be referred to as a display device 200. For example, the display driving circuit 300 mounted on a circuit film, such as a tape carrier package (TCP), a chip on film (COF), and a flexible printed circuit (FPC), may be attached to the display panel 400 using a tape-automated bonding (TAB) method or may be mounted on a non-display area of the display panel 400 using a chip on glass (COG) or a chip on plastic (COP) method.

The host 100 may control the overall operation of the display system 10. The host 100 may generate image data IDT to be displayed on the display panel 400 and may transmit the image data IDT to the display driving circuit 300.

The host 100 may include an application processor but is not limited thereto. The host 100 may be implemented as various types of processors, such as a central processing unit (CPU), a microprocessor, a multimedia processor, and a graphics processor. In some implementations, the host 100 may be implemented as an integrated circuit (IC), a mobile application processor (AP), or a system on chip (SoC).

The host 100 may include a display processor 110, a sync generator 120, and an interface 130. The display processor 110 may control the operation of the display device 200. The display processor 110 may transmit the image data IDT to be displayed on the display device 200 to the display device 200 through the interface 130.

The display processor 110 may generate the image data IDT to be displayed on the display panel 400 and may transmit the image data IDT to the display driving circuit 300. The display panel 400 may display images in units of frames, and the image data IDT may correspond to each of a plurality of frames. In some implementations, the display processor 110 may transmit the image data IDT through a main channel 140. The interface 130 may be connected to the display driving circuit 300 through the main channel 140. The interface 130 may transmit the image data IDT to the display driving circuit 300 through the main channel 140. Herein, the main channel 140 may be described with the same meaning as a main link.

The host 100 may transmit the image data IDT to the display driving circuit 300. The host 100 may provide the image data IDT to the display device 200 through the main channel 140 according to a high-speed serial interface (HSSI). As an example, the host 100 may provide the image data IDT to the display device 200 according to a mobile industry processor interface (MIPI) standard, but this is only an example and is not necessarily limited thereto. The host 100 may transmit a synchronization packet for timing control to the display driving circuit 300. In some implementations, the host 100 may transmit the synchronization packet to the display driving circuit 300 through the main channel 140.

The sync generator 120 may generate sync signals ss that synchronize the host 100 with the display driving circuit 300. Specifically, the sync signals ss may synchronize internal clock signals of the display driving circuit 300 with clock signals generated by the host 100. The sync generator 120 may generate the sync signals ss based on driving information of the display panel 400. The driving information of the display panel 400 may include a pixel resolution of the display panel 400, a vertical back porch, a vertical front porch, a horizontal back porch, a horizontal front porch, and a frame rate of the display panel 400.

The sync generator 120 may generate first sync signals and second sync signals. The first sync signals and the second sync signals may be included in the sync signals ss. The first sync signal may refer to a signal indicating the start of a frame and the second sync signal may refer to a signal indicating the start of each horizontal line in a frame. For example, the first sync signal may be a modulation signal of a vertical sync signal, and the second sync signal may be a horizontal sync signal.

The sync generator 120 may generate the first sync signal and the second sync signal differently. In some implementations, at least one of the pulse width, the number of pulses, and the pulse pattern of the first sync signal may be different from that of the second sync signal. For example, the sync generator 120 may set the duty ratio of the first sync signal to be different from the duty ratio of the second sync signal. For example, the sync generator 120 may generate the first sync signal and the second sync signal so that the pulse width of the first sync signal is less than the pulse width of the second sync signal. As another example, the sync generator 120 may generate two pulses of the first sync signal during a horizontal period and one pulse of the second sync signal during a horizontal period but is not limited thereto. The first sync signal may be generated differently from the second sync signal in various ways.

The sync generator 120 may generate the sync signals ss and transmit the sync signals ss to the display driving circuit 300. In some implementations, the host 100 may transmit the sync signals ss to the display driving circuit 300 through the interface 130. The interface 130 may transmit the sync signals ss to the display driving circuit 300 through an auxiliary channel 150. The interface 130 may be connected to the display driving circuit 300 through the auxiliary channel 150. For example, the host 100 may provide the sync signals ss to the display device 200 according to a display port (DP) standard, but this is only an example and is not necessarily limited thereto.

As the host 100 generates at least one of the first sync signal and the second sync signal differently and transmits the same to the display driving circuit 300, the display driving circuit 300 may control the timing of driving the display panel 400 based on the sync signals ss. When underrun occurs, the host 100, according to some implementations, may delay the timing of generating the first sync signal by the number of data lines in a section corresponding to the underrun. The host 100, according to some implementations, may determine whether the frame can be transmitted within the time for determining whether the next frame can be updated after underrun occurs. When the frame cannot be transmitted, the host 100 may stop transmitting frame data in a section where the frame is updated by the first sync signal of the next section. Thus, image quality deterioration may be prevented even when underrun occurs.

The display driving circuit 300 may convert the image data IDT received from the host 100 into image signals for driving the display panel 400 and may supply the image signals to the display panel 400, thereby displaying images on the display panel 400.

The display driving circuit 300 may operate in video mode in which the image data IDT is received from the host 100. The display device 200 may display moving images and still images in video mode. The display driving circuit 300 may control the image data IDT received from the host 100 in the video mode to be displayed on the display panel 400 without storing the image data IDT in internal memory of the display driving circuit 300.

The display driving circuit 300 may include an interface 310, a display controller 320, and a driver 350. The display driving circuit 300 may further include other components in addition to those shown in FIG. 1, if necessary. For example, the display driving circuit 300 may further include memory.

The display driving circuit 300 may receive the image data IDT through the main channel 140. The interface 310 may be connected to the host 100 through the main channel 140. The interface 310 may receive the image data IDT through the main channel 140. In some implementations, the interface 130 of the host 100 and the interface 310 of the display driving circuit 300 may include an MIPI. The interface 130 of the host 100 and the interface 310 of the display driving circuit 300 may include the MIPI and general-purpose input/output (GPIO). For example, the sync signals ss may be transmitted from the host 100 to the display driving circuit 300 through the GPIO but are not limited thereto. The interface 130 of the host 100 and the interface 310 of the display driving circuit 300 may include a Display Port (DP). In video mode, the image data IDT received through the main channel 140 may be transmitted to the display controller 320.

The display controller 320 may control the overall operation of the display driving circuit 300. The display controller 320 may include a data processor 330 and a timing controller 340. The data processor 330 may convert the image data IDT and transmit the data DATA from the conversion to the driver 350.

The display driving circuit 300 may receive the sync signals ss through the auxiliary channel 150. The interface 310 may be connected to the host 100 through the auxiliary channel 150. The interface 310 may receive the sync signals ss through the auxiliary channel 150. The sync signals ss received through the auxiliary channel 150 may be transmitted to the display controller 320. The sync signals ss may be transmitted to the timing controller 340.

The timing controller 340 may generate internal control signals CS for driving the display panel 400 based on the sync signals ss received through the auxiliary channel 150. The timing controller 340 may transmit the internal control signals CS to the driver 350.

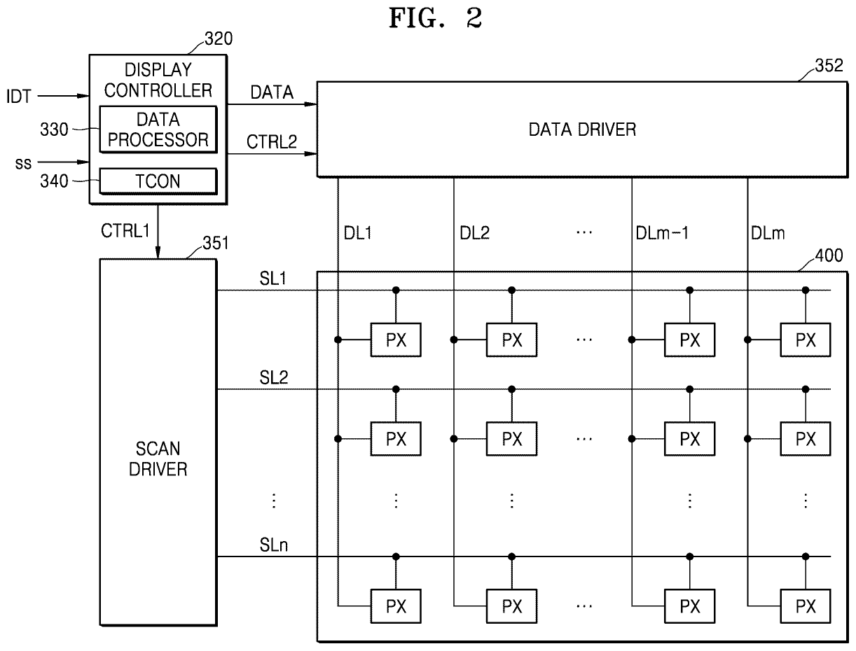

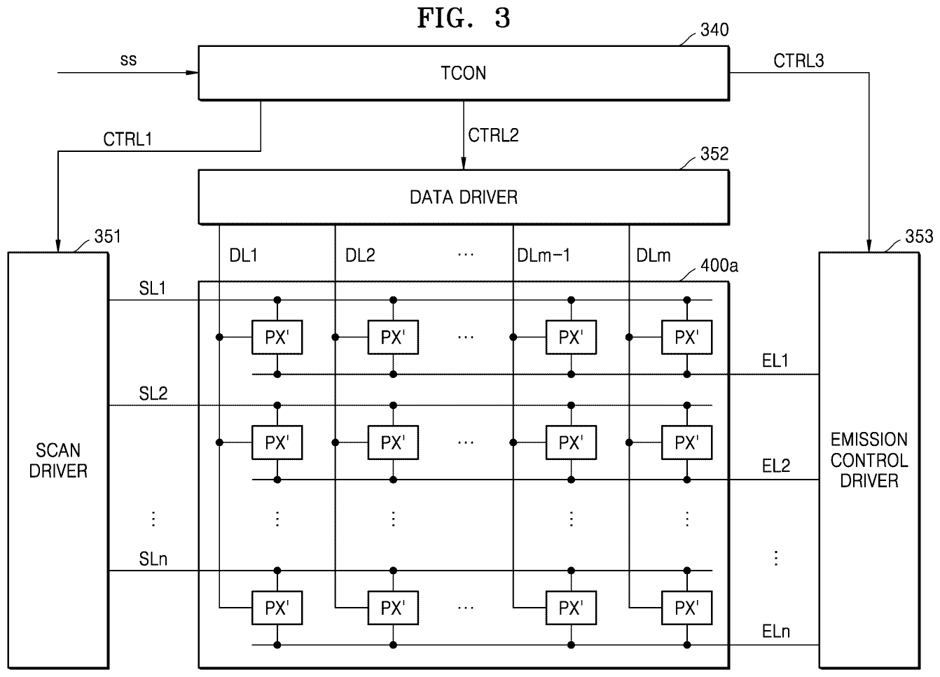

The timing controller 340 may generate the internal control signals CS that control the driver 350 to drive the display panel 400 based on the sync signals ss. The driver 350 may provide a voltage to gate lines and data lines of the display panel 400 in response to the internal control signals CS. The operations of the timing controller 340 and the driver 350 are described in detail below with reference to FIGS. 2 and 3.

According to some implementations, the timing controller 340 may control the timing of generating the internal control signals CS based on the sync signals ss and the image data IDT. According to some implementations, the timing controller 340 may control the timing of generating the internal control signals CS such that the internal control signals CS are generated only when the sync signals ss and the image data IDT are normally input. According to some implementations, the timing controller 340 may control the timing of generating the internal control signals CS such that the internal control signals CS are generated only when the sync signals ss and signals corresponding to the image data IDT are received simultaneously. Since the start time of the next frame data may change when underrun occurs, the display driving circuit 300 according to some implementations may transmit the corresponding time information to the host 100 so that the frame can be rendered by taking this into account.

The timing controller 340 may receive the sync signals ss including the first sync signal and the second sync signal. The timing controller 340 may distinguish between the first sync signal and the second sync signal. For example, the timing controller 340 may detect a signal with a small pulse width as the first sync signal and detect a signal with a pulse width larger than the first sync signal as the second sync signal. Since the above description corresponds to an example of distinguishing between sync signals, the timing controller 340 may distinguish between the sync signals in various ways.

The display driving circuit 300 may control components of the display driving circuit 300 based on the sync signals ss. In some implementations, the host 100 may switch the mode of the display system 10 and may transmit a command for switching the mode of the display driving circuit 300 to the display driving circuit 300. When receiving the command, the display driving circuit 300 may start switching the mode of the display driving circuit 300 and may control the components of the display driving circuit 300 to switch the mode of the display driving circuit 300 from normal mode to low-power mode or from low-power mode to normal mode based on the sync signals ss. As another example, the display driving circuit 300 may be turned on or off based on the sync signals ss.

The display panel 400, which is a display unit for displaying an actual image, may include one of display devices which receive electrically transmitted image signals and display a two-dimensional image, such as a thin film transistor-liquid crystal display (TFT-LCD), an organic light-emitting diode (OLED) display, a field emission display, and a plasma display panel (PDP) display. The display panel 400 may be implemented as another type of flat display or flexible display panel.

In some implementations, the display panel 400 may include an Low-Temperature Polycrystalline Oxide (LTPO) display panel produced through an LTPO process. The display panel 400 may be driven at a low frame rate. In some implementations, the display panel 400 may be driven at a frame rate of 5 Hz or less. When the display panel 400 is driven at a low frame rate in video mode, the display system 10 may enter low-power mode. When the display system 10 enters the low-power mode, the host 100 and the display driving circuit 300 may also enter the low-power mode. While the host 100 enters the low-power mode, at least some of the components of the host 100 for driving the display panel 400 may be driven at low power or may be turned off. While the display driving circuit 300 enters the low-power mode, at least some of the components of the display driving circuit 300 for driving the display panel 400 may be driven at low power or may be turned off. The low-power mode may be maintained for a plurality of vertical periods. The vertical period may correspond to one frame section. In the low-power mode, the components are driven at low power for a plurality of vertical periods. Thus, the components may be driven for a longer period of time in low-power mode than when driven at low power for a plurality of horizontal periods, thereby reducing the power consumption. Although the display system 10 enters the low-power mode, the internal clock signal of the display driving circuit 300 and the clock signal generated by the host 100 may be synchronized based on the sync signals ss transmitted through the auxiliary channel 150.

The display system 10 may include the main channel 140 for transmitting data and may include the auxiliary channel 150 for transmitting the sync signals ss for synchronizing the host 100 with the display panel 400. According to some implementations, the sync signals ss may include a modified first sync signal that notifies the start of the frame, and, when underrun occurs, the host 100 may be controlled to change the time of generating the first sync signal. According to some implementations, when the underrun occurs and frame data is transmitted beyond the requested transmission time within the frame, the host 100 may be controlled to stop transmitting the frame data in a frame section following the underrun, that is, at the time of updating the next frame data. The display driving circuit 300 may generate the internal control signals CS only when the sync signals ss and the frame data are input simultaneously and may output panel driving signals DCS based thereon. Although the underrun occurs, serious image defects in the panel may be alleviated by queuing the panel driving signals DCS rather than advancing the same.

FIG. 2 is a block diagram of a partial configuration of a display device according to some implementations. Since a display controller 320, a timing controller 340, a data processor 330, drivers 351 and 352, and a display panel 400 of FIG. 2 correspond to the display controller 320, the timing controller 340, the data processor 330, the driver 350, and the display panel 400 of FIG. 1, respectively, repeated description thereof may be omitted.

Referring to FIGS. 1 and 2, the driver 350 may include a scan driver 351 and a data driver 352. However, the display driving circuit 300 may not include the scan driver 351, and the scan driver 351 may be included in the display device 200 as a separate configuration from the display driving circuit 300.

The display panel 400 may include a plurality of pixels PX arranged in a matrix form and may display images in units of frames. The display panel 400 may include scan lines SL1 to SLn arranged in a row direction, data lines DL1 to DLm arranged in a column direction, and pixels PX formed at intersections of the scan lines SL1 to SLn and the data lines DL1 to DLm.

The scan driver 351 may sequentially select the pixels PX by sequentially applying scan signals to the pixels PX on a line-by-line basis. The scan driver 351 may sequentially select the scan lines SL1 to SLn by sequentially supplying a scan-on signal to the scan lines SL1 to SLn in response to a scan control signal CTRL1 provided from the timing controller 340. According to the scan-on signal output from the scan driver 351, the scan lines SL1 to SLn may be sequentially selected. As grayscale voltages corresponding to the pixels PX are applied to the pixels PX connected to the selected scan lines through the data lines DL1 to DLm, the display operation may be performed. During a period in which the scan-on signal is not supplied to the scan lines SL1 to SLn, a scan-off signal (e.g., scan voltage at a logic high level) may be supplied to the scan lines SL1 to SLn.

The data driver 352 may convert data DATA corresponding to the image data IDT into image signals that are analog signals in response to a data control signal CTRL2 and may provide the image signals to the data lines DL1 to DLm. The data driver 352 may include a plurality of channel amplifiers, wherein each of the plurality of channel amplifiers may provide image signals to at least one corresponding data line. According to some implementations, signals transmitted through the scan lines SL1 to SLn and the data lines DL1 to DLm may correspond to the panel driving signals DCS of FIG. 1.

The timing controller 340 may control the overall operation of the display panel 400. The timing controller 340 may be implemented as hardware, software, or a combination of hardware and software. For example, the timing controller 340 may be implemented as digital logic circuits and registers performing various functions below.

The timing controller 340 may receive the sync signals ss and may generate the internal control signals (e.g., scan control signal CTRL1 and data control signal CTRL2) for controlling the data driver 352 and the scan driver 351 to display the image data IDT on the display panel 400. The timing of generating the internal control signals CTRL1 and CTRL2 may be controlled according to whether the sync signals ss and the image data IDT in FIG. 1 are normally supplied.

The data processor 330 may convert the format of the image data IDT received from the outside of the display driving circuit 300 to conform to the interface specification with the data driver 352 and may transmit the converted data DATA from the conversion to the data driver 352.

FIG. 3 is a block diagram explaining a display panel according to some implementations. The timing controller 340, the driver 350, and the display panel 400 of FIG. 1 may correspond to a timing controller 340, drivers 351, 352, and 353, and a display panel 400a of FIG. 3, respectively. In FIG. 3, an OLED panel is described as an example of the display panel 400 of FIG. 1 and repeated description of components with the same reference numerals as in FIG. 2 is omitted.

Referring to FIG. 3, the display panel 400a may include a plurality of data lines DL1 to DLm, a plurality of scan lines SL1 to SLn, a plurality of emission control lines EL1 to ELn, and a plurality of pixels PX′ positioned between the lines. Each of the plurality of pixels PX′ may be connected to a scan line, a data line, and an emission control line, each corresponding thereto.

The emission control driver 353 may be connected to the plurality of emission control lines EL1 to ELn and may sequentially apply emission control signals to the pixels PX′ to control the emission time of the pixels PX′. Each of the pixels PX′ may include a corresponding OLED and may include a transistor that supplies or blocks a driving current corresponding to an image signal to the OLED. The emission control signal provided through each of the plurality of emission control lines EL1 to ELn may control the emission time of the OLED by turning on/off the transistor providing the driving current to the OLED.

According to some implementations, signals transmitted through the scan lines SL1 to SLn, the data lines DL1 to DLm, and the emission control lines EL1 to ELn may correspond to the panel driving signals DCS of FIG. 1.

The luminance value of each pixel PX′ may vary depending on the duty ratio of the emission control signals. As the duty ratio of the emission control signals (i.e., the length of the on section of the emission control signals for a period of the emission control signals) increases, the time for which the pixels PX′ emit light may increase and high luminance may be shown. As such, the emission control driver 353 may adjust the luminance of the display panel 400a by adjusting the pulse width modulation (PWM) of the emission control signals under the control by the timing controller 340.

The timing controller 340 may control the emission control driver 353 to generate the emission control signals based on the sync signals ss. The timing controller 340 may generate a control signal CTRL3 for controlling the emission control driver 353 based on the sync signals ss.

According to some implementations, the timing of generating the internal control signals CTRL1, CTRL2, and CTRL3 may be controlled depending on whether the sync signals ss and the image data IDT in FIG. 1 are normally supplied. In some examples, by controlling the internal control signals to be generated only when the sync signals ss and the signals corresponding to the image data IDT are input simultaneously, the image quality deterioration of output data is minimized even when underrun occurs.

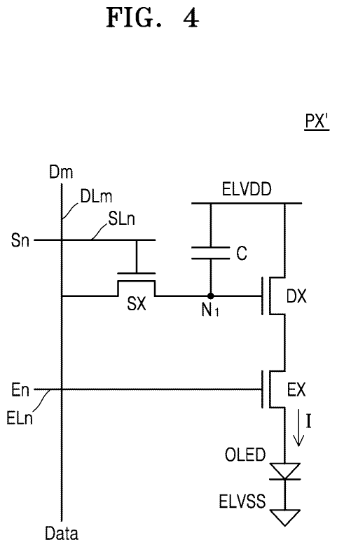

FIG. 4 is a circuit diagram of a pixel according to some implementations of FIG. 3. A pixel PX′ of FIG. 4 may be the pixel PX′ of FIG. 3. Hereinafter, description is given with reference to FIGS. 3 and 4 together.

Referring to FIG. 4, the pixel PX′ may include a switching transistor SX, a driving transistor DX, an emission control transistor EX, a capacitor C, and an organic light-emitting diode OLED. Although three transistors and one capacitor are illustrated in FIG. 4, implementations are not limited thereto. The number of transistors and capacitors of the pixel PX′ may be variously configured.

A first electrode of the switching transistor SX may be connected to a data line DLm, a gate terminal thereof may be connected to a scan line SLn, and a second electrode thereof may be connected to a first node N₁. The switching transistor SX may be turned on in response to a scan signal Sn transmitted through the scan line SLn to transmit an image signal Dm received through the data line DLm to the first node N₁.

The capacitor C may be connected between the first node N₁ and a first power supply voltage ELVDD. The capacitor C may store a voltage corresponding to the voltage difference between the voltage of the first node N₁ and the first power supply voltage ELVDD for a certain period. When the driving transistor DX is turned on, the organic light-emitting diode OLED may emit light with a driving current I corresponding to the voltage applied to the first node N₁ by the capacitor C.

A first electrode of the driving transistor DX may be connected to an emission control transistor EX, a gate terminal thereof may be connected to the first node N₁, and a second terminal thereof may be connected to the first power supply voltage ELVDD. Since the gate electrode of the driving transistor DX is connected to the first node N₁ and the voltage applied to the first node N₁ is maintained by the capacitor C, the driving transistor DX may be turned on.

The pixel PX′ may include the emission control transistor EX connected between the first electrode of the driving transistor DX and an anode electrode of the organic light-emitting diode OLED to control the time and period when images are displayed by light emission of the organic light-emitting diode OLED. Specifically, the emission control transistor EX includes a gate electrode connected to the n^{th} emission control line ELn, a second electrode connected to the first electrode of the driving transistor DX, and a first electrode connected to the anode electrode of the organic light-emitting diode OLED.

During a period when the emission control transistor EX is turned on in response to the n^{th} emission control signal En transmitted through the n^{th} emission control line ELn, a driving current path may be formed between the driving transistor DX and the organic light-emitting diode OLED so that the driving current I flows through the path and the organic light-emitting diode OLED may display images according to the image signal Dm.

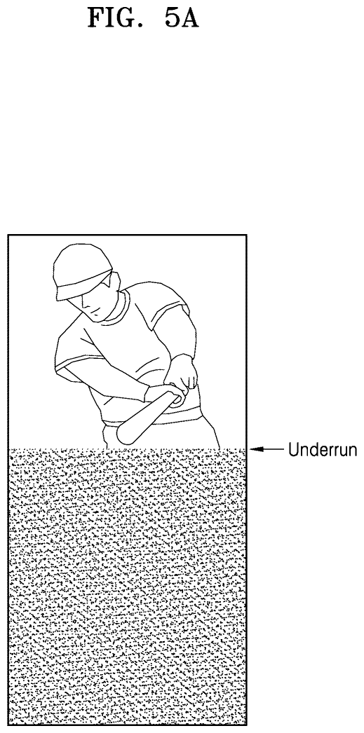

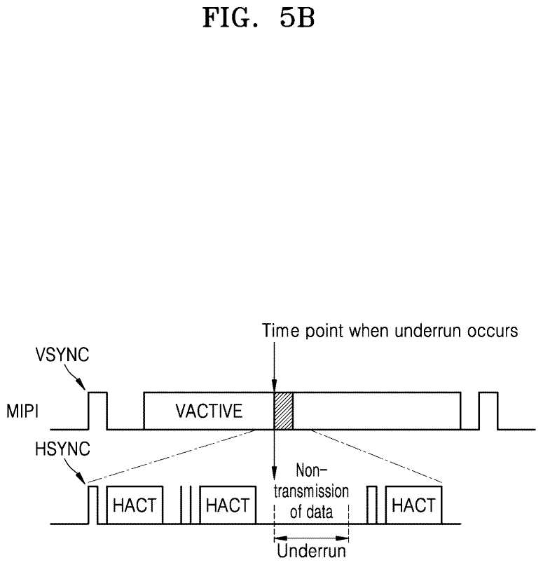

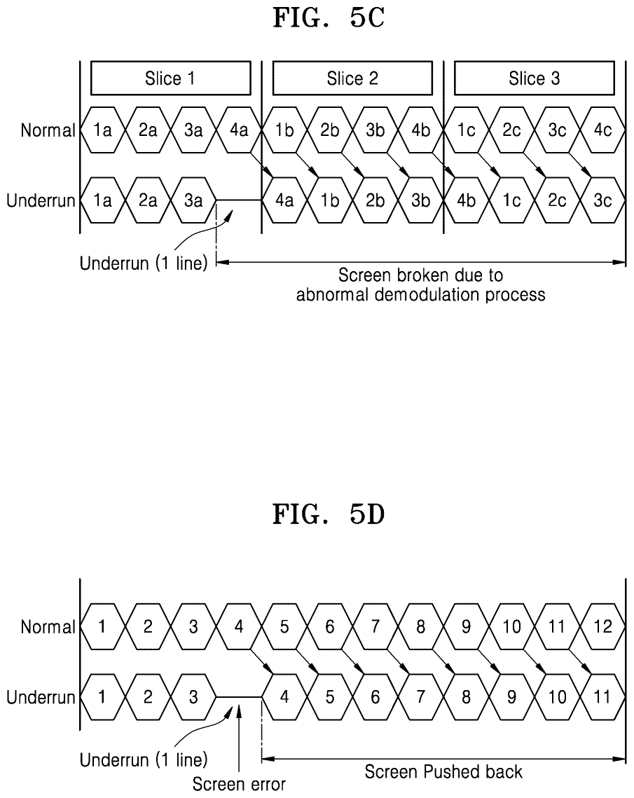

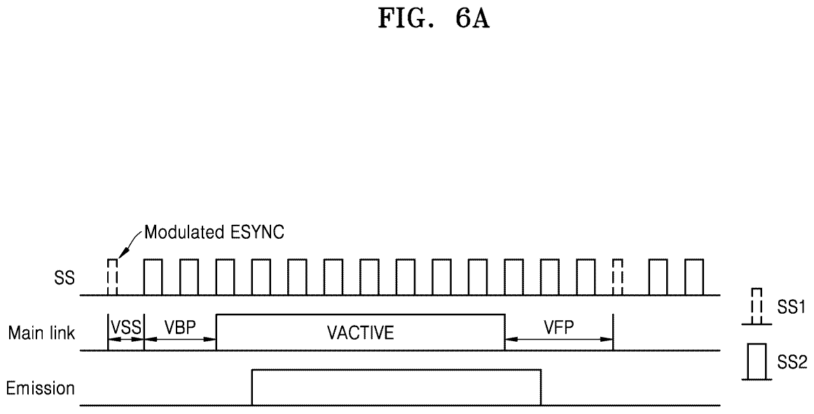

FIG. 5A shows an example of output image data when underrun occurs.

Referring to FIG. 1 together, the host 100 may perform logical operations for computation and system control on the CPU, GPU, and NPU, as well as various functions, such as multimedia, modem, and memory controller. Therefore, various circuit blocks may use a common resource, such as memory, through a common bus. When the common resource is accessed by different components simultaneously, a specific component may be queued according to priority. When the DPU is queued, the DPU may not receive data from a memory when the display panel is driven and may not transmit image data to the display panel. This may be defined as underrun.

Referring to FIG. 1, frame data may be continuously transmitted from the host 100 to the display driving circuit 300 in accordance with the display timing, but the transmission may be temporarily stopped by the internal operation of the host 100, causing the underrun. When data needs to be transmitted in accordance with the display panel's driving timing according to the video mode, serious display distortion may occur from the time when the underrun occurs. Referring to FIG. 5A, it may be seen that serious screen defects occur in which image data is distorted and output for the lines below after the underrun occurs, as the display distortion occurs after the underrun occurs.

FIG. 5B is a diagram explaining signal driving when underrun occurs.

Referring to FIG. 5B, after a vertical sync signal VSYNC is input, a vertical active section VACTIVE where data can be substantially input is formed. In the vertical active section VACTIVE, a plurality of horizontal sync signals HSYNC may be output at regular intervals, and horizontal line data may be transmitted in a horizontal active section HACT corresponding thereto.

When underrun occurs, data may not be transmitted from the time when the underrun occurs to the time when data transmission is resumed, as in some implementations of FIG. 5B. Accordingly, the horizontal sync signals HSYNC and the horizontal active section HACT corresponding thereto may not be output.

FIGS. 5C and 5D are diagrams explaining data output when underrun occurs.

FIG. 5C illustrates data output when underrun occurs with a data compression process, and FIG. 5D illustrates data output when underrun occurs without the data compression process. In FIGS. 5C and 5D, a hexagon may indicate that data has been normally received and a blank may indicate that data has not been normally received. In FIGS. 5C and 5D, a slice may be a compression modulation unit of frame data.

Referring to FIG. 5C, when underrun occurs with the data compression process, data may not be transmitted at the time when the data should be written to the pixels of the corresponding line and data included in a slice may be pushed back. Accordingly, abnormal data may be modulated and the screen defects may be shown after the underrun occurs. According to some implementations, unintended data may be restored during a compression decoding process, and thus images, such as noise, may appear on the screen.

Referring to FIG. 5D, when underrun occurs without the data compression process, data may be pushed back by the corresponding line, thereby causing screen tearing or color inversion.

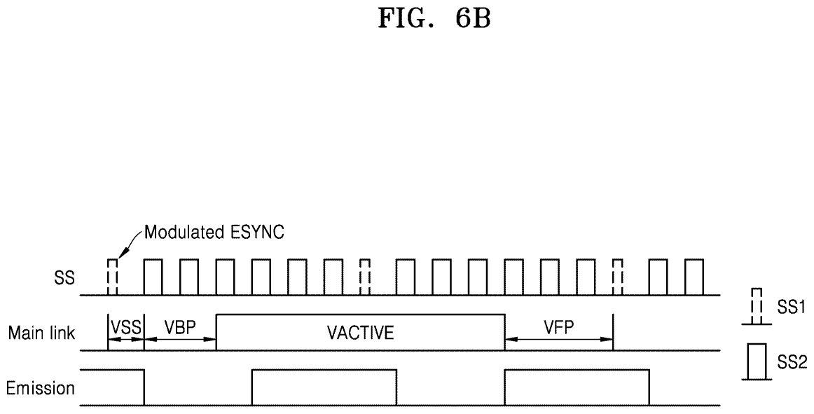

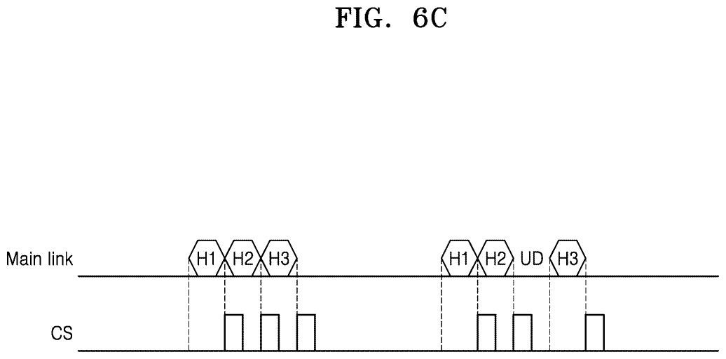

FIGS. 6A and 6B are timing diagrams for driving sync signals and pixels according to some implementations.

Referring to FIG. 6A, disclosed is a timing diagram of sync signals SS, data signals of a main link, and emission signals. The sync signals SS may include first sync signals SS1 and second sync signals SS2. The first sync signal SS1 may indicate the start of a frame or may be generated at a point indicating the time when a light-emitting signal starts. According to some implementations, the second sync signals SS2 may be generated at intervals of the horizontal sync signals between the first sync signals SS1 generated in response to the start point of one frame. The second sync signals SS2 may be used to generate the panel driving signals. The first sync signals SS1 may be obtained by changing the pulse width, the number of pulses, the pulse code, and the like differently from the second sync signals SS2.

In FIGS. 6A and 6B, an example of the sync signals SS during a normal display operation is disclosed. During the normal display operation, the generation period of the vertical sync signal VSYNC may be determined by the sum of the number of lines of the display and the number of lines of a preset vertical front porch VFP section, a vertical start signal VSS section, and a vertical back porch VBP section. The first sync signals SS1 may be modulated in accordance with the time when the vertical sync signal VSYNC is generated. The first sync signals SS1 may be obtained by modulating the vertical sync signal VSYNC.

Referring to FIG. 6B, for a display panel where N light-emitting signals are segmented within one frame, the first sync signals SS1 may be transmitted multiple times by dividing the time point of the vertical sync signal into N equal parts and the emission signals may be generated to correspond to the first sync signals SS1, respectively.

The sync signals SS shown in FIGS. 6A and 6B may be fixedly transmitted or modulated. The sync signals SS shown in FIGS. 6A and 6B transmitted from the outside may be applied to the display driving circuit. In some implementations, the sync signals SS may have the same meaning as external sync signals.

FIG. 6C is a timing diagram of an operation in a display driving circuit according to some implementations.

In the timing diagram of FIG. 6C, a hexagon may represent a section where data corresponding to one line is transmitted. In the timing diagram of FIG. 6C, UD may represent an underrun section where data corresponding to one line is not transmitted.

In video mode, line data of corresponding images should be continuously transmitted in accordance with the timing of the panel. However, when the DPU is not ready for data at that time, the main link may not transmit the data.

In video mode, the display driving circuit may receive the external sync signals SS having a period level of the horizontal sync signals HSYNC to drive the display at a variable refresh rate (VRR) and may generate internal control signals CS based on the external sync signals SS. However, when the external sync signals SS are input but data is not received due to underrun, the display panel may cause abnormal screen defects and a very wide range of screen breaks.

Herein, in response to a section where the main link does not transmit data, the internal control signals CS may be queued without generating a clock signal. The timing controller may generate the internal control signals CS only when a start signal of line data or line data is fully received from the main link. According to some implementations, the start signal of the line data may include a horizontal sync signal HSYNC or a horizontal start signal HSS. Referring to FIG. 6C, the timing controller may control the internal control signals CS not to be generated when a signal corresponding to data is not applied. The sync signals may have default input values and the control of the generation timing of the internal control signals CS may vary depending on whether the signal corresponding to data is applied. The control of the generation timing of sync signals, to be described below, may be intended to easily control the display output after the underrun occurs.

Referring to FIG. 6C, the internal control signals CS corresponding to first line data H1 may be output to transition in the next section of the first line data H1. Herein, the next section of the first line data H1 may be a section corresponding to second line data H2 transmitted following the first line data H1.

The output timing and output waveform of the internal control signals CS shown in FIG. 6C may be an example, and the internal control signals CS may be output to have various waveforms, pulse widths, and pulse numbers in response to the applied line data. According to some implementations, the internal control signals CS may not be output in the section immediately following the data DATA applied from the data processor 330 and the timing may be delayed. According to some implementations, as shown in FIG. 6C, the internal control signals CS corresponding to the first line data H1 may be output to transition in the next section of the first line data H1. Alternatively, the internal control signals CS corresponding to the first line data H1 may be output to transition in a section that is more delayed than the next section of the first line data H1.

The timing controller may control the internal control signals CS to be generated only when signals corresponding to line data and sync signals are input simultaneously. The data driver and the scan driver may operate based on the internal control signals CS and a normal screen may be output accordingly.

The display driving circuit according to some examples may generate signals for writing data to a panel based only on sync signals. When generating signals for writing data to the panel based only on sync signals, data may not be input due to underrun. In this case, a gate signal for the write operation is generated but a signal that should be stored in the corresponding pixel is not input to the data line. Thus, an unintended value may be written to the corresponding pixel. When the underrun is canceled and data finally arrives, the data is written behind the corresponding line. Thus, when underrun occurs, a distorted image is shown on the display. The display driving circuit may control the internal control signals to be generated when the conditions for receiving sync signals and receiving data through the main link are simultaneously satisfied and not to be generated when the data is not received through the main link even though the sync signals are received.

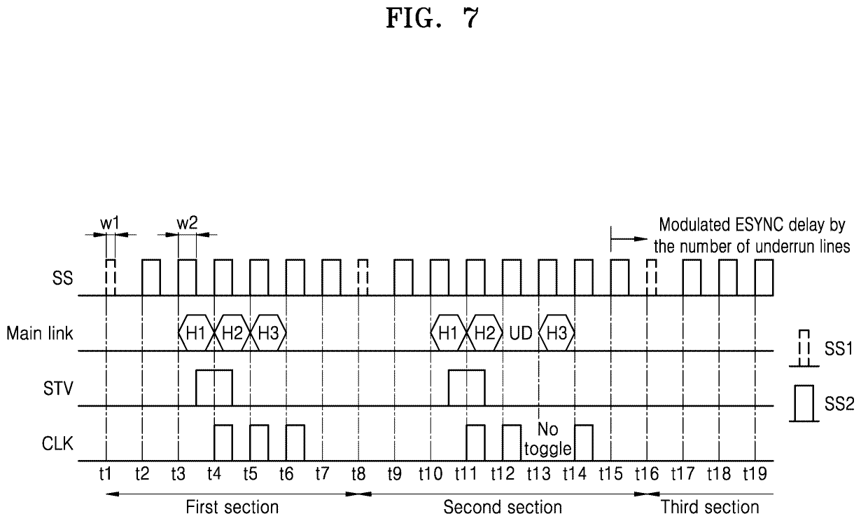

FIG. 7 is a timing diagram of an operation of a display system according to a first embodiment.

Referring to FIG. 7, a timing diagram of sync signals SS, data transmitted through a main link, and control signals STV and CLK output from a driver is shown.

The sync signals SS may include first sync signals SS1 and second sync signals SS2. The sync signals SS may include inter-chip interface signals for synchronizing the timing of the host and the display device. According to some implementations, the sync signals SS may be generated in a period of line data, for example, a period of a horizontal sync signal or a fixed period of a similar value. According to some implementations, the first sync signal SS1 may be a modulation signal of a vertical sync signal and the second sync signal SS2 may be a horizontal sync signal. According to some implementations, the first sync signal SS1 may be a signal having a modulated waveform that informs the display driving circuit of the start time of emission signal or a scheduled frame.

A pulse width W1 of the first sync signal SS1 may be less than a pulse width W2 of the second sync signal SS2. The host may generate the first sync signal SS1 and the second sync signal SS2 by adjusting the PWM of the sync signals SS. The host may set the duty ratio of the first sync signal SS1 to be different from the duty ratio of the second sync signal SS2. For example, the host may generate the first sync signal SS1 and the second sync signal SS2 so that the pulse width W1 of the first sync signal SS1 is less than the pulse width W2 of the second sync signal SS2 but is not limited thereto. The host may generate the first sync signal SS1 and the second sync signal SS2 so that the pulse width W1 of the first sync signal SS1 is greater than the pulse width W2 of the second sync signal SS2.

At time point t1, the first sync signal SS1 may transition from a first level to a second level. In some implementations, the first level may be a logic low level and the second level may be a logic high level. At each time point t2 to t7, the second sync signal SS2 may transition from the first level to the second level. The second sync signal SS2 may be provided with 6 pulses in the first section corresponding to one frame.

According to some implementations, in the first section, one first sync signal SS1 and six second sync signals SS2 may be provided. The first section may be a section where image data corresponding to the first frame is received.

The control signals STV and CLK output from the driver may be generated based on line image data H1, H2, and H3 transmitted through the main link. According to some implementations, the transition time of the first control signal STV output from the driver may be delayed by a certain time from the input time point t3 of the line image data transmitted through the main link. The transition time of the second control signal CLK output from the driver may be a period of the horizontal sync signal HSYNC that is half of the first control signal STV. According to some implementations, there may be a plurality of horizontal sync signals HSYNC between the time when data is input and the time when data is actually written to the panel. The first control signal STV may transition considering the delay between the time when data is input and the time when data is actually written to the panel. The second control signal CLK may transition by a half period behind the first control signal STV. According to some implementations, the number of pulses of the second control signal CLK in the first section may correspond to the number of line image data transmitted through the main link. The pulse width, the number of pulses, the pulse period, etc. of the first control signal STV may be different from those of the second control signal CLK. According to some implementations, the first control signal STV may be a start signal of a shift register included in the driver. According to some implementations, the second control signal CLK may be a signal for sequentially transmitting signals to the next gate. The first control signal STV and the second control signal CLK may be implemented so that the gate signal can be sequentially moved on a line-by-line basis.

Referring to FIG. 7, the second section may be a section including a case in which underrun of image data corresponding to the second frame occurs. When underrun occurs at time point t12 while image data is received through the main link, the third line data H3 may not be transmitted and the third image data H3 may be transmitted at time point t13.

Referring to FIG. 7, the number of pulses of the second sync signal SS2 in the second section may be added by the number of lines where the underrun occurs. According to some implementations, since the number of lines of image data in which underrun occurs is 1, the number of pulses of the second sync signal SS2 in the second section may be output as 7. The number of pulses of the second sync signal SS2 in the first section where underrun did not occur may be 6, while the number of pulses of the second sync signal SS2 in the second section where underrun occurs may be 7. By increasing the number of pulses of the second sync signal SS2 in the section where the underrun occurs, the start time of the third section, which is the next frame section of the second section, may be delayed by the increased number of pulses of the second sync signal SS2. According to some implementations, the start time of the third section may be the transition time of the first sync signal SS1.

Referring to the second section of FIG. 7, the second control signal CLK may be controlled not to toggle at the time point following the section where the underrun occurs. The second control signal CLK may be controlled not to toggle at the time point following the section where the underrun occurs, thereby preventing the output of the shift register corresponding to the section where the underrun occurs from moving to the next stage. In some implementations such as those of FIG. 6C, the internal control signals may be controlled not to be output at the time point following the section where the underrun occurs. Since the internal control signals are control signals for driving the driver, the second control signal CLK corresponding thereto may not be output at the time point when the internal control signals are not applied.

FIG. 7 shows a method of controlling sync signals of a host according to the first embodiment. According to the method of controlling the sync signals of the host according to the first embodiment, second sync signals SS2 may be additionally output in proportion to the number of line data in which underrun occurs in a section where the underrun occurs. Alternatively, the first sync signal SS1 of the section corresponding to the next frame may be delayed by the number of line data in which the underrun occurs in the section where the underrun occurs. The method of controlling the sync signals of the host according to the first embodiment may be an example of a host operating in first mode.

According to the method of controlling the sync signals of the host according to the first embodiment, the time point when a start signal of a frame section following the section where the underrun occurs, that is, the first sync signal SS1, is generated may be delayed by the number of line data in which the underrun occurs in the section where the underrun occurs. According to the method of controlling the sync signals of the host according to the first embodiment, when a small underrun occurs, the frame transmission delay may be small and the change in screen brightness that may occur due to the underrun may be small. Additionally, panel driving signals in the display driving circuit may be implemented substantially the same as when no underrun occurs, making design easier.

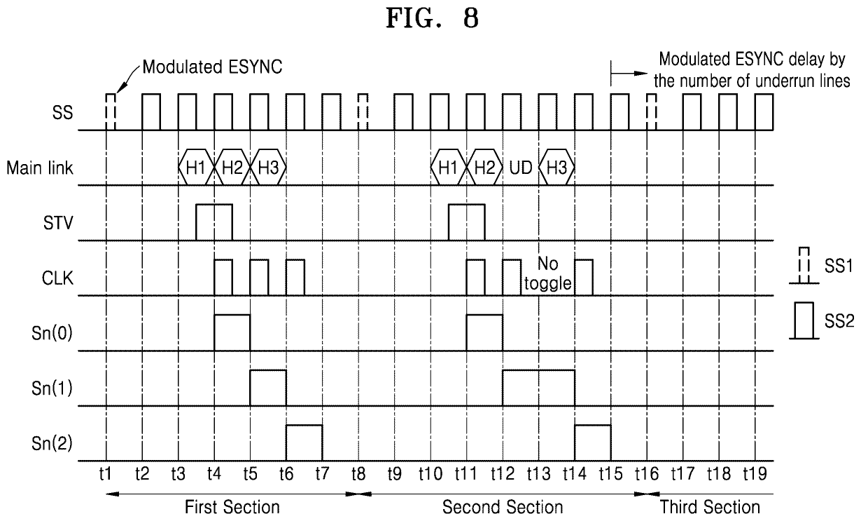

FIG. 8 is a timing diagram of an operation of a display system according to the first embodiment. Since the timing diagram of sync signals SS, a main link, a first control signal STV, and a second control signal CLK shown in FIG. 8 is similar to that of the sync signals SS, the main link, the first control signal STV, and the second control signal CLK shown in FIG. 7, description of overlapping configurations is omitted.

Referring to FIG. 8, a timing diagram of a plurality of scan signals Sn(0), Sn(1), and Sn(2) applied through the scan line of FIG. 1 is additionally disclosed. The first scan signal Sn(0) may transition from the first level to the second level at time point t4, which is the first transition time of the second control signal CLK and may be maintained at the second level from time point t4 to time point t5. The second scan signal Sn(1) may transition from the first level to the second level at time point t5, which is the second transition time of the second control signal CLK and may be maintained at the second level from time point t5 to time point t6. The third scan signal Sn(2) may transition from the first level to the second level at time point t6, which is the third transition time of the second control signal CLK and may be maintained at the second level from time point t6 to time point t7. That is, in the first section where image data is normally applied, the plurality of scan signals Sn(0), Sn(1), and Sn(2) are each activated at the transition time of the second control signal CLK and the activation may be maintained for a period corresponding to the pulse period of the second control signal CLK.

Referring to the second section of FIG. 8, the second control signal CLK may not toggle in the signal following the section where underrun occurs. In some implementations, such as those of FIG. 6C, the internal control signals may be controlled not to be output at the time point following the section where the underrun occurs. Since the internal control signal is a control signal for driving the driver, when the internal control signal is not applied, the corresponding second control signal CLK may not be output. Accordingly, the activation section t12 to t14 of the corresponding second scan signal Sn(1) may increase in duration, compared to the first section.

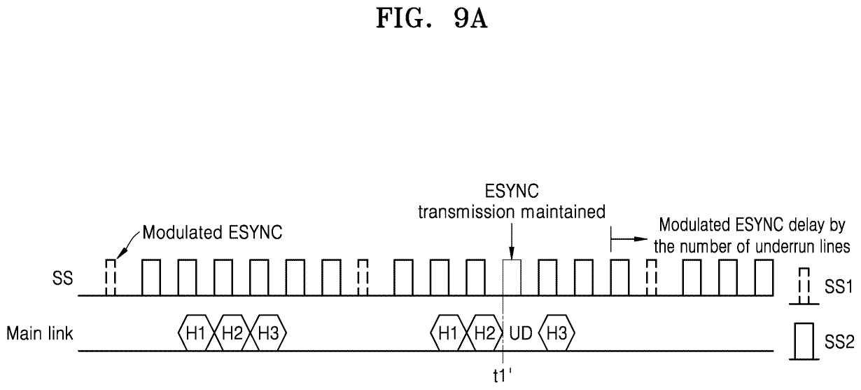

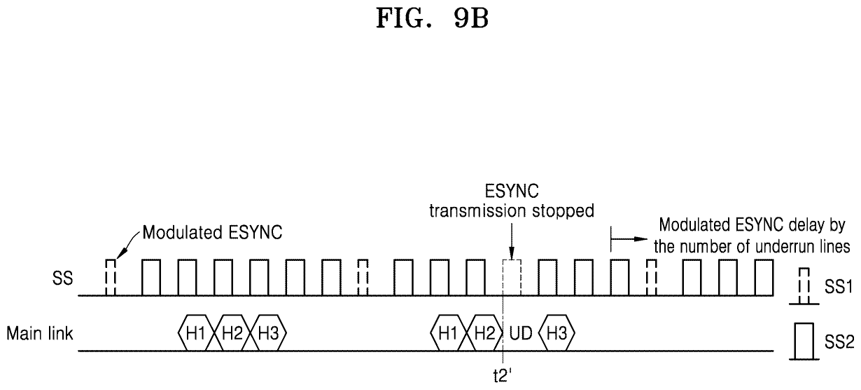

FIG. 9A is a diagram showing the output of sync signals in a host according to the first embodiment.

Referring to FIG. 9A, sync signals SS and image data transmitted on the main link are shown. Referring to FIG. 9A, the output of the second sync signal SS2 may be maintained at time point t1′ when underrun occurs. According to some implementations of FIG. 9A, the second sync signal SS2 at time point t1′ when underrun occurs may be output. The second sync signals SS2 may be additionally output in the section corresponding to the frame in proportion to the number of line data in the section where the underrun occurs.

FIG. 9B is a diagram showing the output of sync signals in the host according to the first embodiment.

Referring to FIG. 9B, sync signals SS and image data transmitted on the main link are shown. Referring to FIG. 9B, the second sync signal SS2 may not be output at time point t2′ when underrun occurs. According to some implementations of FIG. 9B, at time point t2′ when underrun occurs, the second sync signal SS2 is not output. The second sync signals SS2 may be additionally output in the section corresponding to the frame in proportion to the number of line data in the section where the underrun occurs. In some implementations of FIG. 9B, the number of pulses of the second sync signal SS2 in the second section may be the same as the number of pulses of the second sync signal SS2 in the first section.

According to some implementations, the start time of the first sync signal SS1 in the next section may be delayed by the number of line data where the underrun occurs and the number of second sync signals SS2 in the previous section that delays the start point of the first sync signal SS1 may be provided in various ways.

Referring to FIGS. 9A and 9B, when underrun occurs, the line data of the frame and the corresponding horizontal sync signal are not transmitted from the main link. The second sync signals SS2 may be continuously transmitted at the same interval as the non-transmission period of data due to underrun (FIG. 9A) or may not be transmitted (FIG. 9B).

According to the method of controlling the display system according to the first embodiment, the host and the display driving circuit may include a first channel for transmitting frame data, according to one example, a main link, and a second channel for exchanging sync signals for timing synchronization between the host and the display driving circuit. When underrun occurs in the image data transmitted through the first channel and certain line data is not transmitted, the generation position of the first sync signal indicating the start time of the transmission section of the next frame data may be delayed by the line section where the underrun occurs.

The second sync signal at the time when the underrun occurs may be continuously transmitted or the second sync signal at the time when the underrun occurs may not be output.

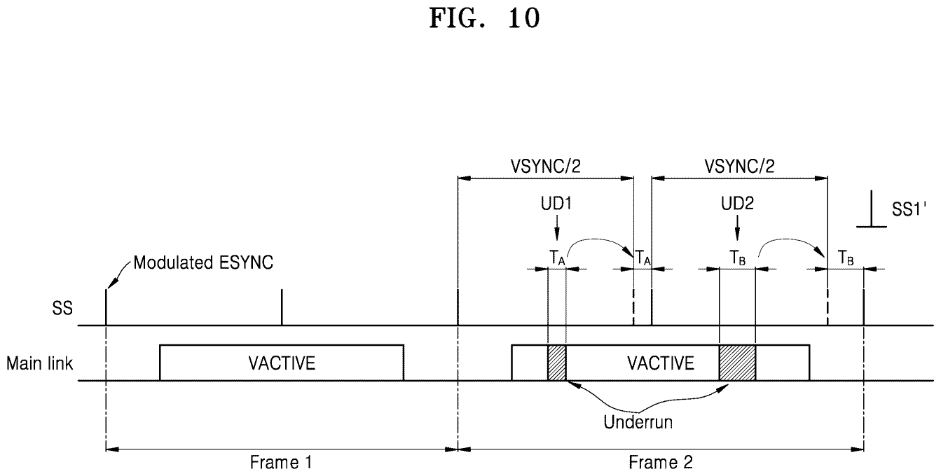

FIG. 10 is a diagram explaining the delay of sync signals in the host according to the first embodiment.

Referring to FIG. 10, in response to one frame driving section Frame 1, and Frame 2, sync signals SS may include a plurality of first sync signals SS1′. This number may be determined depending on the number of separated emission signals, which are the driving signals of the display panel but is not limited thereto.

Referring to FIG. 10, two first sync signals SS1′ may be implemented in response to one frame driving section Frame 1 and Frame 2. In this case, an example of applying the first embodiment is shown when underrun occurs.

Referring to FIG. 10, when underrun occurs, each first sync signal SS1′ may be delayed in response to the underrun occurrence section. Referring to FIG. 10, in response to a first underrun occurrence section UD1, the first sync signal SS1′ may be delayed. In response to a second underrun occurrence section UD2, the first sync signal SS1′ may be delayed. That is, referring to FIG. 10, in the case where the plurality of first sync signals SS1′ are generated in the section Frame 2 corresponding to one frame, when underrun occurs at several time points during the frame transmission section, the first sync signals SS1′ generated immediately after the underrun may be immediately delayed in response to the number of lines where the underrun occurs.

However, according to another embodiment, based on one frame unit, the first sync signal SS1′ corresponding to the next frame may be delayed at once in response to a plurality of underrun sections.

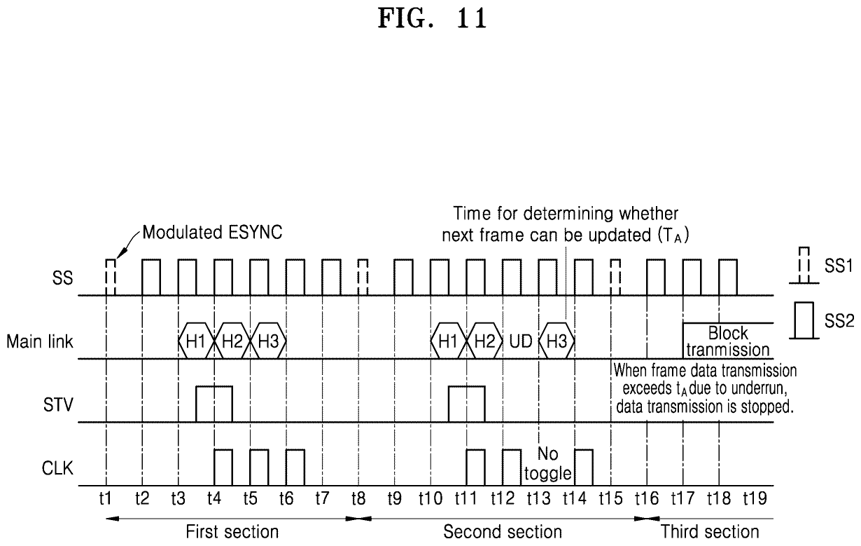

FIG. 11 is a timing diagram of an operation of a display system according to a second embodiment. Since the timing diagram of a main link, a first control signal STV, and a second control signal CLK shown in FIG. 11 is the same as that of the main link, the first control signal STV, and the second control signal CLK shown in FIG. 7, description of overlapping configurations is omitted.

In describing the second embodiment of FIG. 11, for convenience of explanation, the description is given through comparison with the first embodiment. Unlike the first embodiment, which delays the start time of the first sync signal corresponding to the next frame section of the section UD where underrun occurs, the first sync signal SS1 and the second sync signal SS2 included in the sync signals SS according to the second embodiment may be output at the same interval as the section where underrun does not occur. In some implementations of FIG. 11, sync signals SS in the first section and sync signals SS in the second section may be the same.

Referring to FIG. 11, without delaying the start time point t15 of the first sync signal SS1 corresponding to the third section, which is the next frame section after the section where the underrun occurs, a time point T_{A} for determining whether the next frame can be updated after the underrun occurs and before the start of the next frame section, i.e., from time point t12 to time point t15 of FIG. 11, may be set. At the time point T_{A}, it may be determined whether frame data to be transmitted due to the underrun exceeds the allowable time within the frame to determine whether to transmit the frame data.

Referring to FIG. 11, when the amount of frame data to be transmitted due to the underrun is less than the allowable time within the frame at the time point T_{A} for determining whether the next frame can be updated, data transmission may be permitted in the frame section after the underrun occurs, that is, the third section. When the amount of frame data to be transmitted due to the underrun is greater than the allowable time within the frame at the time point T_{A} for determining whether the next frame can be updated, data transmission may be stopped in the frame section after the underrun occurs, that is, the third section.

Compared to the first embodiment, the host control method according to the second embodiment can maintain fixed display frame timing despite the underrun, thereby improving display quality with an accurate frame rate. Additionally, when rendering frames, it may be easy to manage the content creation time point. At this time, there may be a possibility of frame delay for frames that have already been drawn and the amount of brightness change may be greater depending on the amount of underrun than in the first embodiment. The method of controlling sync signals of a host according to the second embodiment may be an example of a host operating in second mode.

According to the host control method according to the second embodiment, when underrun occurs in a very small number of lines, the defect caused by the underrun may be absorbed within the VFP and VBP sections and the display driving frequency may be maintained constant, thereby improving display quality.

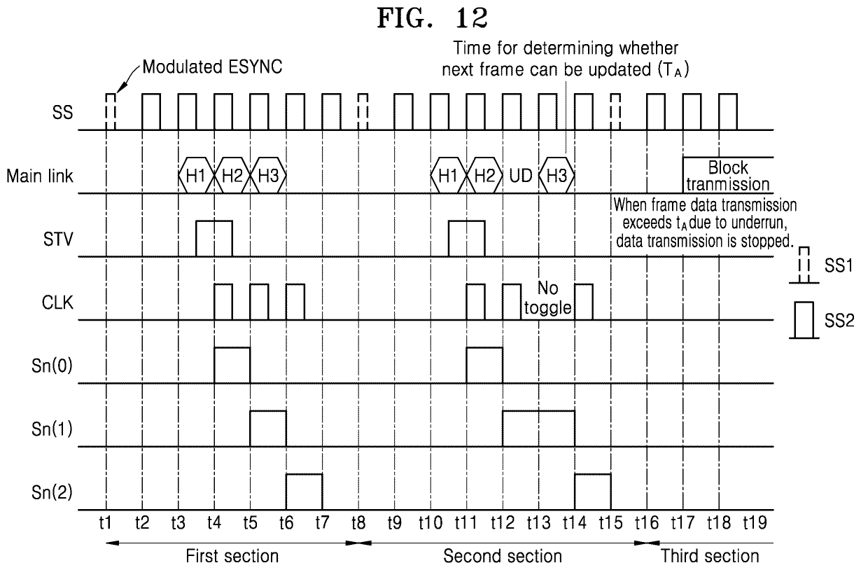

FIG. 12 is a timing diagram of an operation of a display system according to the second embodiment.

Since the timing diagram of a main link, a first control signal STV, a second control signal CLK, a first scan control signal Sn(0), and a second scan control signal Sn(1), and a third scan control signal Sn(2) shown in FIG. 12 is the same as that of the main link, the first control signal STV, the second control signal CLK, the first scan control signal Sn(0), the second scan control signal Sn(1), and the third scan control signal Sn(2) shown in FIG. 8, a description of overlapping configurations is omitted.

According to the method of controlling the display system according to the second embodiment, the host and the display driving circuit may include a first channel for transmitting frame data, according to one example, a main link, and a second channel for exchanging sync signals for timing synchronization between the host and the display driving circuit. Even when specific line data is not transmitted due to underrun in the image data transmitted through the first channel, the first sync signal SS1 and the second sync signal SS2 may be transmitted and output at the same interval as when no underrun occurs. The determination time point may be set in a section between the time when underrun occurs and the start time of the section corresponding to the next frame data. At the determination time point, when the number of line data in which underrun occurs is greater than the sum of the total number of frame lines, frame output may be stopped in the next frame section after the underrun occurs. Hereinafter, the stopped frame data may be transmitted according to the first sync signal SS1 that can update the frame data. According to some implementations of FIGS. 11 and 12, when transmission of frame data is stopped in the third section, the stopped frame data may be transmitted according to the first sync signal SS1 of the fourth section.

According to the second embodiment, software that renders frame data may be easily synchronized with display hardware timing, thereby reducing the number of resynchronization operations and reducing operational overhead. Additionally, the software may more accurately determine the position or state of each object that makes up the rendered image over time, thereby improving screen quality deterioration.

In some implementations of FIGS. 9A and 9B, the second sync signal SS2 at the time when the underrun occurs may be continuously transmitted or the second sync signal SS2 at the time when the underrun occurs may not be output.

The first and second implementations cannot be applied simultaneously and either one can be selected and applied.

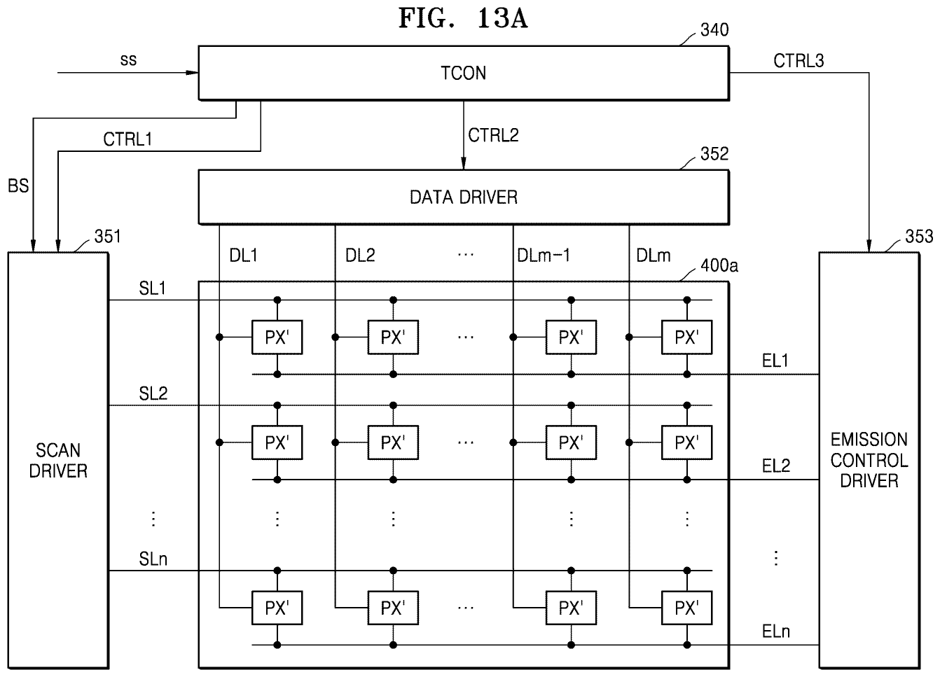

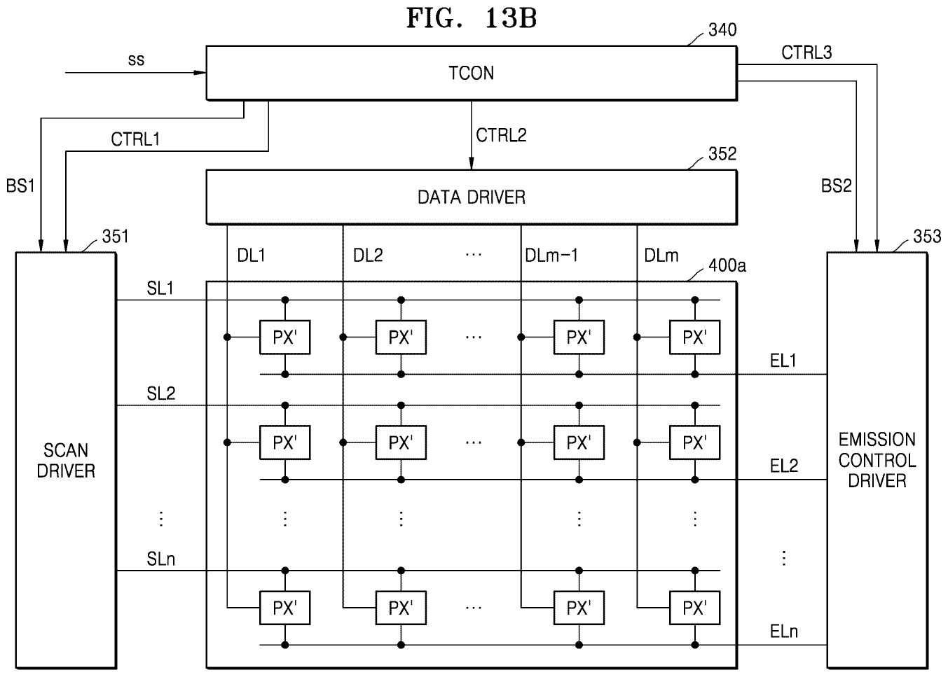

FIG. 13A is a block diagram of a display system according to some implementations.

A timing controller 340, drivers 351, 352, and 353, and a display panel 400a of FIG. 13A may correspond to the timing controller 340, the drivers 351, 352, and 353, and the display panel 400a of FIG. 3, respectively. In FIG. 13A, overlapping description of the same numerals as in FIG. 3 is omitted.

Referring to FIG. 13A, the timing controller 340 may generate block control signals BS. The block control signals BS may be applied to the scan driver 351. According to some implementations, the scan driver 351 may include a NAND gate, and the block control signals BS may be applied as input to the NAND gate. According to some implementations, the NAND gate included in the scan driver 351 may be a circuit that prevents the gate signal from being output to the display panel.

FIG. 13B is a block diagram of a display system according to some implementations.

A timing controller 340, drivers 351, 352, and 353, and a display panel 400a of FIG. 13B may correspond to the timing controller 340, the drivers 351, 352, and 353, and the display panel 400a of FIG. 3, respectively. In FIG. 13B, overlapping description of the same numerals as in FIG. 3 is omitted.

Referring to FIG. 13B, the timing controller 340 may generate first block control signals BS1 and second block control signals BS2. The first block control signals BS1 may be applied to the scan driver 351. The second block control signals BS2 may be applied to the emission control driver 353. According to some implementations, the scan driver 351 and the emission control driver 353 may include a NAND gate and the first block control signals BS1 and the second block control signals BS2 may be applied as input to the NAND gate. According to some implementations, the NAND gate included in the scan driver 351 and the emission control driver 353 may be a circuit that prevents the gate signal from being output to the display panel. According to some implementations, when the first block control signals BS1 and the second block control signals BS2 are applied to the scan driver 351 and the emission control driver 353, respectively, changes in screen brightness due to underrun may be completely eliminated.

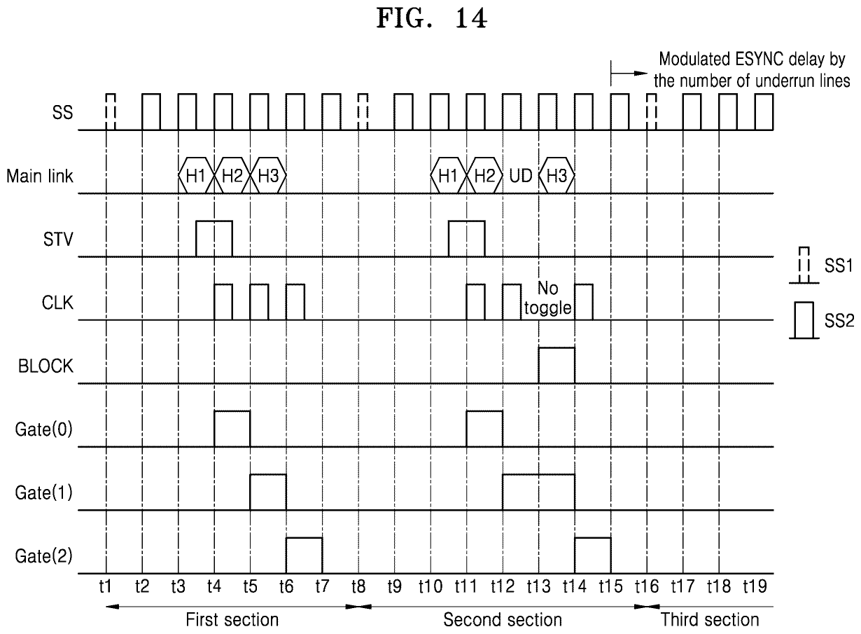

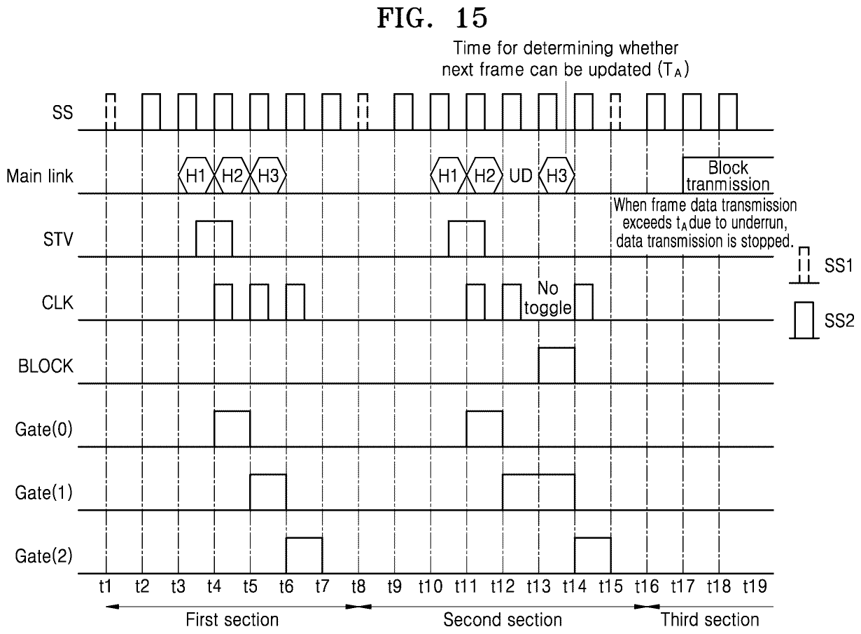

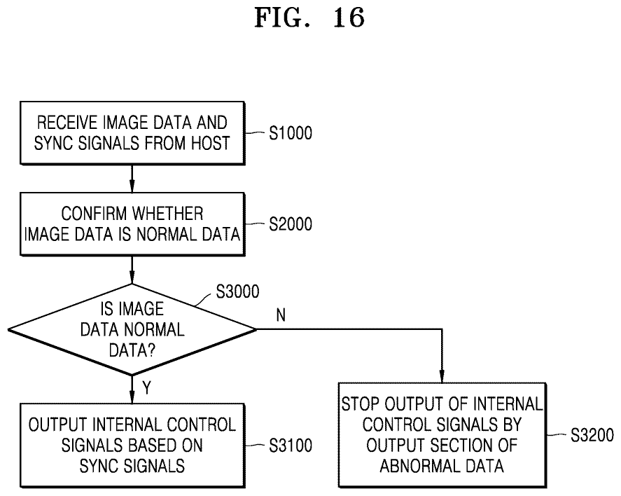

FIG. 14 is a timing diagram applying control of block control signals in the first embodiment. FIG. 15 is a timing diagram applying control of block control signals in the second embodiment. Since the plurality of signals shown in FIGS. 14 and 15 are the same as those described in FIGS. 8 and 12, only the timing diagram of the block control signals BS may be described. According to some implementations, the timing of the block control signals BS may be equally applied to the first block control signals BS1 and the second block control signals BS2.

Referring to FIGS. 14 and 15, at the time when line data generated at the time of underrun is scheduled to be written to the panel, the block control signals BS may be activated to block the signals output to the gate. Referring to FIGS. 14 and 15, in sections where the corresponding data line cannot be written due to underrun, data on the panel may be written longer than the writing section of other gates, resulting in brightness fluctuations. Thus, when the scan driver 351 includes a circuit for closing the gate output, a data write operation may be prevented by activating the block control signals BS. By blocking the emission signals, the emission section may be prevented from being lengthened or shortened due to underrun. Additionally, the data driver may also determine the output according to the line to be used to prevent display distortion from occurring on the panel's data line.

FIG. 16 is a flowchart of a method of operating a display driving circuit, according to some implementations.

Referring to operation S1000, the display driving circuit may receive image data and sync signals from the host. According to some implementations, the image data may be transmitted in units of frames.

Referring to operation S2000, the display driving circuit can confirm whether the image data is normal data. According to some implementations, it may be confirmed whether the image data is normal data by confirming whether a horizontal sync signal corresponding to the image data or a signal equivalent thereto is input. When the horizontal sync signal corresponding to the image data or the equivalent signal is not input, it may be determined that the image data is not normal data. A case where normal data is not input may be defined as a case where underrun occurs.

Referring to operation S3000, the display driving circuit may determine whether to output internal control signals depending on whether the image data is normal data.

Referring to operation S3100, when the image data is normal data, the corresponding horizontal sync signal or the equivalent signal may be input. The display driving circuit may control the internal control signals to be output to the driver based on the corresponding horizontal sync signal and external sync signals.

Referring to operation S3200, when the image data is not normal data, underrun may occur and the corresponding horizontal sync signal or the equivalent signal may not be input. The display driving circuit may control the output of the internal control signals corresponding to a section where the horizontal sync signal is not input, that is, the output section of abnormal data, to be stopped.

When generating internal control signals based on external sync signals to synchronize the timing of the host and the display panel, the display driving circuit that operates in video mode may control the internal control signals to be generated only when signals indicating lines of image data, such as horizontal sync signals or similar signals such as horizontal start signals, are received through the main link and otherwise not to be generated. In other words, the display driving circuit may control the internal control signals to be generated only when the external sync signals and the signals representing lines of image data are input simultaneously. The internal control signals may be applied to the driver to generate a signal to drive the panel. According to some implementations, the signal for driving the panel may be a gate line start signal or a clock signal.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While this disclosure has particularly shown and described the display driving circuit with reference to implementations thereof, it will be understood that various changes in form and details may be made therein without departing from the spirit and scope of the following claims.

1. A display driving circuit operating in a video mode, comprising:
an interface configured to receive, from an external source, sync signals and image data corresponding to each of a plurality of frames;
a data processor configured to receive the image data from the interface and convert the image data to generate a converted image data; and
a timing controller configured to generate internal control signals for driving a driver circuit based on the sync signals and the converted image data,
wherein the internal control signals are configured to be output based on the sync signals and signals corresponding to the image data being input simultaneously into the driver circuit, and
wherein panel driving signals are configured to be output to a display panel based on the internal control signals being output to the driver circuit.

2. The display driving circuit of claim 1, wherein the internal control signals are configured to be output to the driver circuit based on the signals corresponding to the image data being applied to the driver circuit, and
wherein the signals corresponding to the image data include horizontal sync signals.

3. The display driving circuit of claim 1, wherein the sync signals comprise a first sync signal corresponding to a start signal of each of the plurality of frames and a second sync signal that is different from the first sync signal.

4. The display driving circuit of claim 3, wherein at least one of a pulse width, a number of pulses, or a pulse pattern of the first sync signal is different from a corresponding one of a pulse width, a number of pulses, or a pulse pattern of the second sync signal.

5. The display driving circuit of claim 3,
wherein the first sync signal is a start signal of a second section that is a next frame section of a first section, and
wherein the first sync signal is configured to, based on the signals corresponding to the image data being not received in the first section, be delayed by a section in which the signals corresponding to the image data are not received.

6. A host comprising:
an interface configured to transmit image data corresponding to each of a plurality of frames through a first channel and to transmit sync signals through a second channel to a display driving circuit;
a display processor configured to generate the image data; and
a sync generator configured to generate the sync signals,
wherein the sync generator is further configured to generate first sync signals and second sync signals, wherein the second sync signals are different from the first sync signals, and,
when part of the image data generated from the display processor is not transmitted normally to a display device, the host is configured to operate in at least one of
a first mode that delays output of the first sync signals corresponding to a next frame section of a section where part of the image data is not normally received by the display device, or
a second mode that outputs the first sync signals corresponding to the next frame section of the section where part of the image data is not normally received by the display device.

7. The host of claim 6, wherein the first sync signals correspond to a start signal of each of the plurality of frames.

8. The host of claim 7, wherein at least one of a pulse width, a number of pulses, or a pulse pattern of the first sync signals is different from a corresponding one of a pulse width, a number of pulses, or a pulse pattern of the second sync signals.

9. The host of claim 8, wherein the sync generator is further configured to additionally output the second sync signals by a signal section where the image data is not normally transmitted to the display device in the first mode.

10. The host of claim 9, wherein the sync generator is configured not to output the second sync signals at a start of the signal section where the image data is not normally transmitted.

11. The host of claim 9, wherein the sync generator is further configured to output the second sync signals at a start of the signal section where the image data is not normally transmitted.

12. The host of claim 6, wherein, when a signal section where the image data is not normally transmitted in one frame includes a first section and a second section in the first mode,
the delay of the first sync signals corresponding to the first section is output to delay the first sync signals that occur after the first section has passed, and
the delay of the first sync signals corresponding to the second section is output to delay the first sync signals that occur after the second section has passed.

13. The host of claim 8, wherein, in the second mode, the display processor is further configured to determine whether to transmit next frame data based on a number of lines corresponding to a signal section where the image data is not normally transmitted and a number of allowable frame lines.

14. The host of claim 13, wherein the display processor is configured to stop transmitting the next frame data when the number of lines corresponding to the signal section where the image data is not normally transmitted exceeds the number of allowable frame lines, and to transmit the next frame data when the number of lines corresponding to the signal section where the image data is not normally transmitted does not exceed the number of allowable frame lines.

15. A display system operating in video mode, comprising:
a host configured to transmit image data corresponding to each of a plurality of frames through a first channel and to transmit sync signals for synchronizing signals of a host and a display driving circuit through a second channel; and
a display driving circuit configured to generate control signals for driving a display panel based on the sync signals and the image data,
wherein the display driving circuit is further configured to generate the control signals only when the sync signals and the image data are normally input, and to output panel driving signals when the control signals are generated.

16. The display system of claim 15, wherein the display driving circuit comprises a timing controller configured to generate internal control signals applied to a driver circuit for driving the display panel based on the sync signals and the image data,
wherein the timing controller is further configured to output the internal control signals when horizontal sync signals corresponding to the image data are applied to the driver circuit.

17. The display system of claim 15, wherein the sync signals comprise a first sync signal corresponding to a start signal of each of the plurality of frames and a second sync signal of which at least one of a pulse width, a number of pulses, or a pulse pattern is different from a corresponding one of a pulse width, a number of pulses, or a pulse pattern of the first sync signal.

18. The display system of claim 17, wherein the host controls the sync signals to be output in a first mode or in a second mode when the image data is not normally applied to the display driving circuit.

19. The display system of claim 18, wherein the first mode is a mode that delays the output of the first sync signal, and the second mode is a mode that outputs the output of the first sync signal.

20. The display system of claim 19, wherein the host is further configured to delay and output the first sync signal corresponding to a start point of a next frame section by a section corresponding to a signal section where the image data is not normally transmitted to the display driving circuit in the first mode.

21-26. (canceled)
